(19) United States
(12) Patent Application Publication
(10) Pub. No.: US 2011/0242290 A1
(43) Pub. Date: Oct. 6, 2011

(54) IMAGE DISPLAY APPARATUS, IMAGE DISPLAY SYSTEM, AND DISPLAY METHOD

(75) Inventor: Takayuki ARAI, Hamura-Shi (JP)

(73) Assignee: KABUSHIKI KAISHA TOSHIBA, Tokyo (JP)

(21) Appl. No.: 13/040,022

(22) Filed: Mar. 3, 2011

(30) Foreign Application Priority Data
Mar. 30, 2010 (JP) 2010-079843

(51) Int. Cl. H04N 13/04

(52) U.S. Cl. 348/51; 348/E13.036

(57) ABSTRACT

According to one embodiment, an image display apparatus includes a connection module, a power transmitting module, a receiving module and a display module. The connection module is configured to be electrically connected to 3D image viewing glasses. The power transmitting module is configured to transmit power to the 3D image viewing glasses via the connection module. The receiving module is configured to receive information relating to a charging amount of the 3D image viewing glasses. The display module is configured to display an image representing the charging amount of the 3D image viewing glasses based on the information relating to the charging amount.

### CROSS REFERENCE TO RELATED APPLICATION(S)

This application is based upon and claims the benefit of priority from Japanese Patent Application No. 2010-079843 filed on Mar. 30, 2010, the entire contents of which are incorporated herein by reference.

### BACKGROUND

1. Field

Embodiments described herein relate generally to an image display apparatus, an image display system, and a display method.

2. Description of the Related Art

In recent years, with the development of video display technologies, video display apparatus have been proposed which can provide the user with 3D video (a 3D image).

One method for providing a user with 3D video (a 3D image) is to display, sequentially and alternately, images (left-eye images) to be supplied to only the left eye of the user and images (right-eye images) to be supplied to only the right eye of the user. Where 3D video (a 3D image) is provided by this method, shutter glasses may be used which are glasses for 3D image viewing. The shutter glasses are glasses in which switching is made between a transparent state and an opaque state of each of a left-eye shutter and a right-eye shutter. As switching is made between the transparent state and the opaque state, the shutter glasses allows only the left eye of the user to see the image when a left-eye image is displayed on a video display apparatus and allows only the right eye of the user to see the image when a right-eye image is displayed. Since a parallax exists between left-eye images and right-eye images, the user can recognize displayed video (image) as 3D video (a 3D image).

In general, each shutter portion of the shutter glasses employs a liquid crystal device, for example, and is rendered transparent or opaque according to the voltage applied to it. Therefore, to switch between the transparent state and the opaque state, it is necessary to supply power to each shutter portion which employs a liquid crystal device, for example. For driving of the shutter glasses, it is preferable that they be equipped with a battery as a power source. In this case, it becomes necessary to replace or charge up the battery of the shutter glasses. Furthermore, it is simple and convenient that the shutter glasses can be charged up by a video display apparatus (e.g., TV receiver) which displays 3D video (a 3D image).

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary conceptual diagram of a video display system according to an embodiment;

FIG. 2 is an exemplary block diagram showing interval configurations of a DTV and shutter glasses according to the embodiment;

FIG. 3 shows an exemplary general appearance of the DTV displaying a charging status display according to the embodiment;

FIG. 4 shows an exemplary general appearance of the DTV displaying a charging completion display according to the embodiment; and

FIG. 5 is an exemplary flowchart of a process relating to the charging status display and the charging completion display which is executed by the DTV according to the embodiment.

### DETAILED DESCRIPTION

In general, according to one embodiment, an image display apparatus includes a connection module, a power transmitting module, a receiving module and a display module. The connection module is configured to be electrically connected to 3D image viewing glasses. The power transmitting module is configured to transmit power to the 3D image viewing glasses via the connection module. The receiving module is configured to receive information relating to a charging amount of the 3D image viewing glasses. The display module is configured to display an image representing the charging amount of the 3D image viewing glasses based on the information relating to the charging amount.

An exemplary embodiment will be hereinafter described with reference to the drawings.

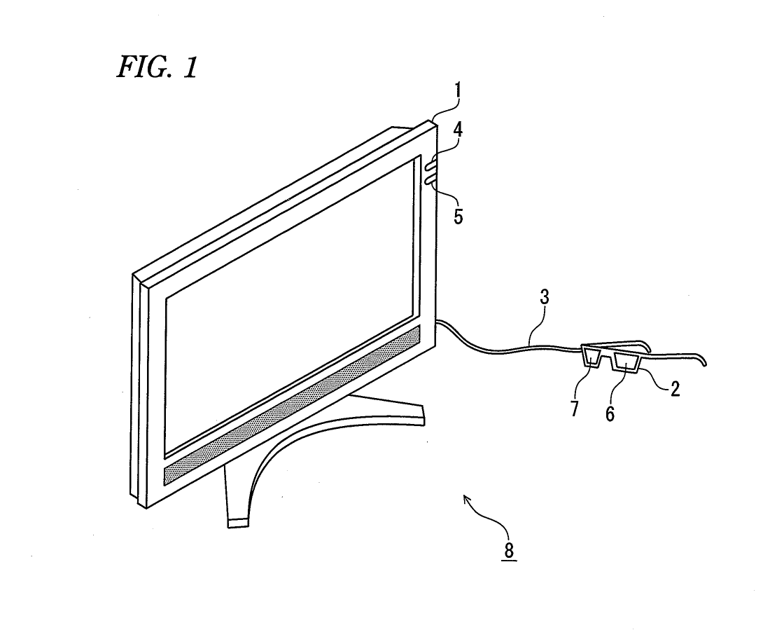

FIG. 1 is an exemplary conceptual diagram of a video display system 8 according to the embodiment. As shown in FIG. 1, the video display system 8 includes a digital TV receiver (DTV) 1 and shutter glasses 2.

The DTV 1 is an example image display apparatus according to the embodiment. The DTV 1 alternately displays left-eye images and right-eye images having a parallax, whereby the user who wears the shutter glasses 2 can see 3D video (frame-sequential method). Although the embodiment employs the DTV 1 as an example image display apparatus, the invention is not limited to such a case. Any of various image display apparatus such as a personal computer (PC) can be employed.

The shutter glasses 2 (3D image viewing glasses) are equipped with a left-eye shutter 6 and a right-eye shutter 7 which are liquid crystal shutters capable of stopping light. The shutter glasses 2 provides the user with 3D video in such a manner that the left-eye shutter 6 and a right-eye shutter 7 are opened and closed at different time points based on a shutter opening/closing signal received from the DTV 1. For example, when a left-eye image is displayed on the DTV 1, the shutter glasses 2 allows only the left eye of the user to see the left-eye image by closing the right-eye shutter 7 (rendering it opaque) and opening the left-eye shutter 6 (rendering it transparent) based on a shutter opening/closing signal received from the DTV 1. When a right-eye image is displayed on the DTV 1, the shutter glasses 2 allows only the right eye of the user to see the right-eye image by closing the left-eye shutter 6 (rendering it opaque) and opening the right-eye shutter 7 (rendering it transparent) based on the shutter opening/closing signal. With this operation, the user can recognize, as 3D video, the video he or she is viewing.

The principle of 3D vision will be described below in more detail. A human usually sees an object with his or her left and right eye which are located at different positions, and a parallax exists between images taken by the left and the right eye. The human can recognize the object as a 3D object by combining the images taken by the left eye and the right eye and having the parallax in his or her brains. Therefore, it is possible to cause a user to recognize video as 3D video by causing the user to see a left-eye image and a right-eye image having a parallax through the respective eyes. Operating in the above-described manner on this principle, the shutter glasses 2 cause the user to recognize, as 3D video, video displayed by the DTV 1.

A connection cable 3 is a cable which connects the DTV 1 and the shutter glasses 2 physically and electrically. In the embodiment, the connection cable 3 complies with the USB (universal serial bus) standard and can transmit information and power. The DTV 1 and the shutter glasses 2 can communicate with each other via the connection cable 3, and the DTV 1 can supply power to the shutter glasses 2 via the connection cable 3. The main purpose of the connection cable 3 is to supply power to the shutter glasses 2 and, in general, the connection cable 3 is detached (disconnected) from the DTV 1 and the shutter glasses 2 while the user watches the DTV 1 wearing the shutter glasses 2. Although in the embodiment the connection cable 3 complies with the USB standard, the invention is not limited to such a case. The connection cable 3 may be one that complies with another standard.

A power indicator 4, which is an indicator that employs an LED (light-emitting diode), for example, and is exposed from the surface of the case of the DTV 1, has a function of indicating a power state of the DTV 1. Examples of the power state of the DTV 1 are a power-on state in which the user can view video and a standby state in which the user cannot view video and most of the components in the DTV 1 are not supplied with power. In the embodiment, the power indicator 4 emits green light in the power-on state and emits red light in the standby state. Furthermore, the power indicator 4 does not light while, for example, the DTV 1 is not supplied with power at all.

A charging indicator 5, which is an indicator that employs an LED, for example, and is exposed from the surface of the case of the DTV 1, has a function of indicating a charging status of the shutter glasses 2. The lighting color of the charging indicator 5 varies depending on the charging status of the shutter glasses 2. The relationship between the charging status and the lighting color will be described later. The charging indicator 5 does not light while the shutter glasses 2 are not connected to the DTV 1.

The video display system 8 includes the DTV 1 and the shutter glasses 2. The user who views video being displayed on the DTV 1 while wearing the shutter glasses 2 can recognize it as 3D video.

Next, the interval configurations of the DTV 1 and the shutter glasses 2 will be described in detail.

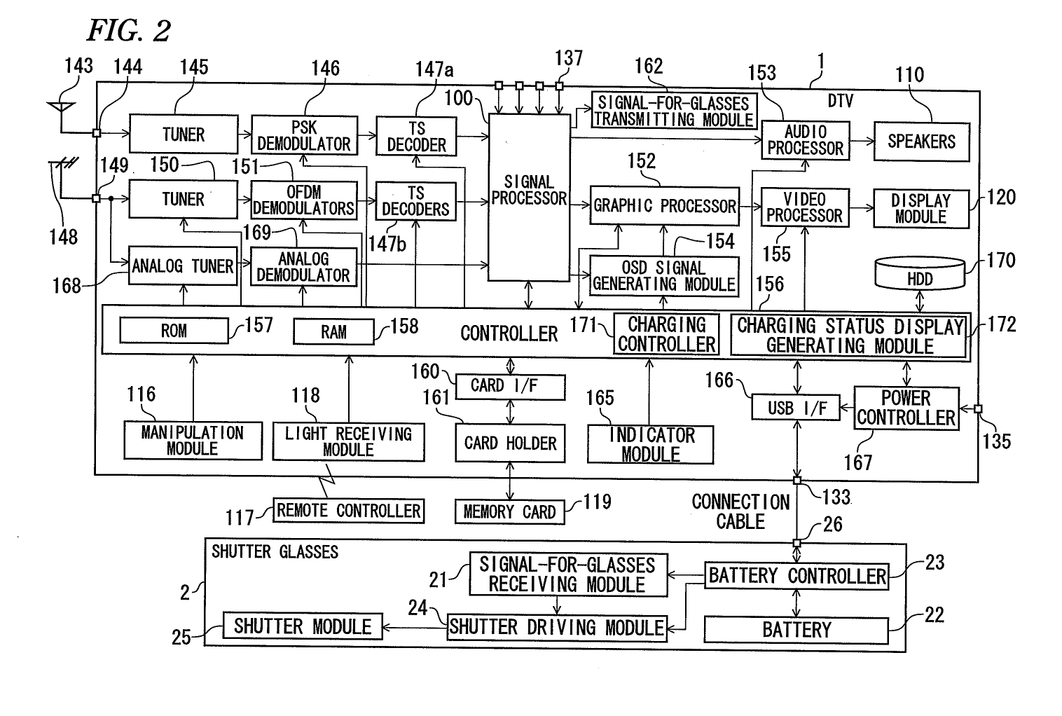

FIG. 2 is an exemplary block diagram showing interval configurations of the DTV 1 and the shutter glasses 2 according to the embodiment.

The interval configuration of the DTV 1 will be described first.

The DTV 1 is equipped with a controller 156 for controlling operations of its individual components. The controller 156 incorporates a CPU (central processing unit) etc. The controller 156 activates a system control program and various processing programs stored in a ROM (read-only memory) 157 in advance in response to a manipulation signal that is input through a manipulation module 116 or transmitted from a remote controller 117 and received by a light receiving module 118. The controller 156 controls operations of the individual components of the DTV 1 according to the activated programs using a RAM (random access memory) 158 as a work memory.

Satellite digital TV broadcast signals received by a BS/CS digital broadcast receiving antenna 143 are supplied to a satellite digital broadcast tuner 145 via an input terminal 144. The tuner 145 tunes in to one of the received digital broadcast signals and supplies the thus-selected digital broadcast signal to a PSK (phase shift keying) demodulator 146. The PSK demodulator 146 demodulates the digital broadcast signal into a transport stream (TS) and supplies the transport stream to a TS decoder 147a. The TS decoder 147a decodes the transport stream into a digital signal containing a digital video signal, a digital audio signal, and a data signal and outputs it to a processor 100. The digital video signal is a digital signal relating to video that can be output by the DTV 1, and the digital audio signal is a digital signal relating to audio that can be output by the DTV 1. The data signal is a digital signal that represents information relating to broadcast programs and contains, for example, program-related information which is information to be used when the DTV 1 generates an electronic program guide (EPG). The program-related information contains a title, detailed information, a program start time, a program end time, etc. of each broadcast program.

Terrestrial digital TV broadcast signals received by a terrestrial digital broadcast receiving antenna 148 are supplied to a terrestrial digital broadcast tuner 150 via an input terminal 149. The tuner 150 tunes in to part of the received digital broadcast signals and supplies the thus-selected digital broadcast signals to respective OFDM (orthogonal frequency division multiplexing) demodulators 151. The OFDM demodulators 151 demodulate the digital broadcast signals into transport streams and supplies the transport streams to respective TS decoders 147b. The TS decoders 147b decode the transport streams into digital video signals, digital audio signals, etc. and output those signals to the processor 100.

The antenna 148 can also receive terrestrial analog TV broadcast signals. The received terrestrial analog TV broadcast signals are distributed by a distributor (not shown) and supplied to an analog tuner 168. The analog tuner 168 tunes in to one of the received analog broadcast signals and supplies the thus-selected analog broadcast signal to an analog demodulator 169. The analog demodulator 169 demodulates the analog broadcast signal and outputs a resulting analog broadcast signal to the processor 100. If, for example, a CATV (common antenna television) tuner is connected to the input terminal 149 to which the antenna 148 is connected, the DTV 1 allows the user to view CATV broadcast programs.

The processor 100 performs proper signal processing on a digital signal that is output from the TS decoder 147a or 147b or the controller 156. More specifically, the processor 100 separates the digital signal into a digital video signal, a digital audio signal, and a data signal. The separated video signal and audio signal are output to a graphic processor 152 and an audio processor 153, respectively. Furthermore, the processor 100 converts a broadcast signal that is output from the analog demodulator 169 into a video signal and an audio signal having prescribed digital formats. Those digital video signal and audio signal are output to the graphic processor 152 and the audio processor 153, respectively. The processor 100 performs prescribed digital signal processing on an input signal that is supplied via a line input terminal 137.

An OSD (on-screen display) signal generating module 154 generates, under the control of the controller 156, an OSD signal for display of a UI (user interface) picture or the like. A data signal that is separated from a digital signal by the processor 100 is converted by the OSD signal generating module 154 into an OSD signal having a proper format, which is output to the graphic processor 152.

The graphic processor 152 decodes the digital video signal that is output from the processor 100. The decoded video signal is combined with (superimposed on) the OSD signal that is output from the OSD signal generating module 154, and a resulting signal is output to the video processor 155. The graphic processor 152 can also select and output the decoded video signal or the OSD signal to the video processor 155.

The video processor 155 performs image quality correction on the output signal of the graphic processor 152 and converts a resulting signal into an analog video signal having such a format as to be displayable by a display module 120. The analog video signal produced by the video processor 155 is displayed on the display module 120.

The display module 120, which is an LCD (liquid crystal display), displays an image using a liquid crystal. A backlight illuminates a liquid crystal panel from behind. The luminance of displayed video can be adjusted by controlling the intensity or the illumination time of light that is emitted from the backlight.

The audio processor 153 converts the received audio signal into an analog audio signal having such a format as to be played back by speakers 110. The analog audio signal is thus output to and played back by the speakers 110.

A card holder 161 is connected to the controller 156 via a card interface (UF) 160. A memory card 119 can be inserted into the card holder 161. The memory card 119 is a storage medium such as an SD (secure digital) memory card, an MMC (multimedia card), or a CF (compact flash) card. The controller 156 can perform information writing and reading, via the card I/F 160, on the memory card 119 that is inserted in the card holder 161.

A USB terminal 133 is connected to the controller 156 via a USB I/F 166. The USB terminal 133 is used as a general USB-compatible port. A cell phone, a digital camera, a card reader/writer for any of various memory cards, an HDD, a keyboard, etc. can be connected to the USB terminal 133 via a hub, for example. The controller 156 can communicate (exchange information) with each device that is connected to the USB terminal 133. The connection cable 3 can be connected to the USB terminal 133, and FIG. 2 shows a case that the connection cable 3 is connected to the USB terminal 133 and a terminal 26 of the shutter glasses 2.

An HDD 170, which is a magnetic storage medium incorporated in the DTV 1, has a function of storing various kinds of information to be held by the DTV 1.

For example, a signal-for-glasses transmitting module 162 is an infrared light transmission module and can transmit a signal to the shutter glasses 2 by infrared light. The signal processor 100 causes the signal-for-glasses transmitting module 162 to transmit an opening/closing signal to the shutter glasses 2 so as to synchronize the display of left-eye images and right-eye images by the display module 120 with the opening/closure (transmission/stop of light) of the left-eye shutter 6 and the right-eye shutter 7. The signal processor 100 causes the signal-for-glasses transmitting module 162 to transmit an opening/closing signal to the shutter glasses 2 so that the right-eye shutter 7 of the shutter glasses 2 is opened (rendered transparent) and the left-eye shutter 6 is closed (rendered opaque) when the display module 120 displays a right-eye image and the right-eye shutter 7 is closed (rendered opaque) and the left-eye shutter 6 is opened (rendered transparent) when the display module 120 displays a left-eye image.

A power controller 167 has a function of controlling the supply of power in the DTV 1. The power controller 167 is connected to a power cable (not shown) via a terminal 135. The power controller 167 is supplied with power when the power cable is connected to, for example, a socket in a home. The power controller 167 supplies power directly to the controller 156 and the USB I/F 166. While the DTV 1 is in a power-on state, the controller 156 being supplied with power supplies power to many components connected to it. While the DTV 1 is in a standby state, the controller 156 supplies power to only a prescribed, small number of components (e.g., manipulation module 116, light receiving module 118, indicator module 165, etc.). The user can change such a power state by operating the manipulation module 116 or the remote controller 117. The USB I/F 166 is supplied with power from the power controller 167 independently of the controller 156.

The indicator module 165 includes the above-mentioned power indicator 4 and charging indicator 5 as well as a controller for controlling the turn-on/off etc. the indicators 4 and 5. The indicator module 165 switches the turn-on/off and the lighting color of each of the power indicator 4 and charging indicator 5 according to an instruction from the controller 156.

The controller 156 is provided with a charging controller 171 and a charging status display generating module 172.

The charging controller 171 has a function of transmitting, to the shutter glasses 2, via the USB I/F 166, a battery residual capacity information transmission request (instruction signal) which is a request for transmitting information of a residual capacity (an amount of residual electricity) of a battery 22. The charging controller 171 instructs the charging status display generating module 172 to generate a signal for one of various kinds of display based on battery residual capacity information that is returned from the shutter glasses 2 in response to a battery residual capacity information transmission request. The charging controller 171 also has a function of calculating, based on acquired battery residual capacity information, a time for which the shutters of the shutter glasses 2 can be driven continuously starting from the current residual capacity. Furthermore, when receiving information indicating completion of charging of the battery 22 (i.e., information indicating that the battery 22 has been charged to a maximum capacity) from the shutter glasses 2, the charging controller 171 instructs the power controller 167 to stop supplying power to the shutter glasses 2 via the USB I/F 166. The power controller 167 stops supplying power to the shutter glasses 2 in response to this instruction. When the charging of the shutter glasses 2 has been completed, charging controller 171 instructs the charging status display generating module 172 to generate a signal for charging status display. In causing the charging status display generating module 172 to generate a signal for charging status display, the charging controller 171 gives an instruction to generate charging status display, battery residual capacity information, and a continuously drivable (usable) time of the shutter glasses 2 to the charging status display generating module 172. In causing the charging status display generating module 172 to generate a signal for charging completion display, the charging controller 171 gives an instruction to generate charging completion display to the charging status display generating module 172.

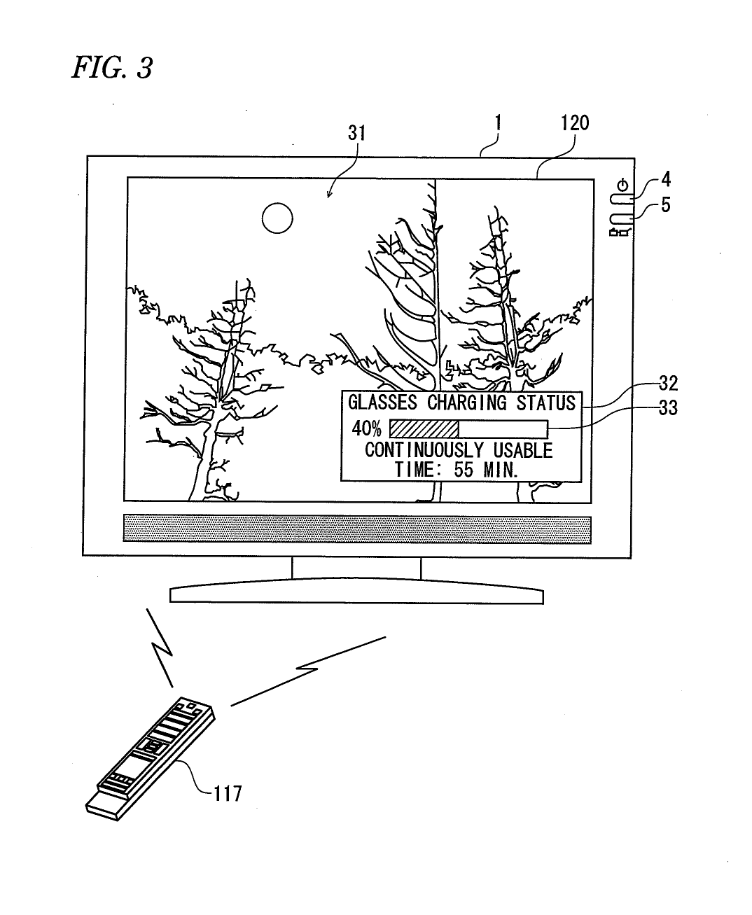

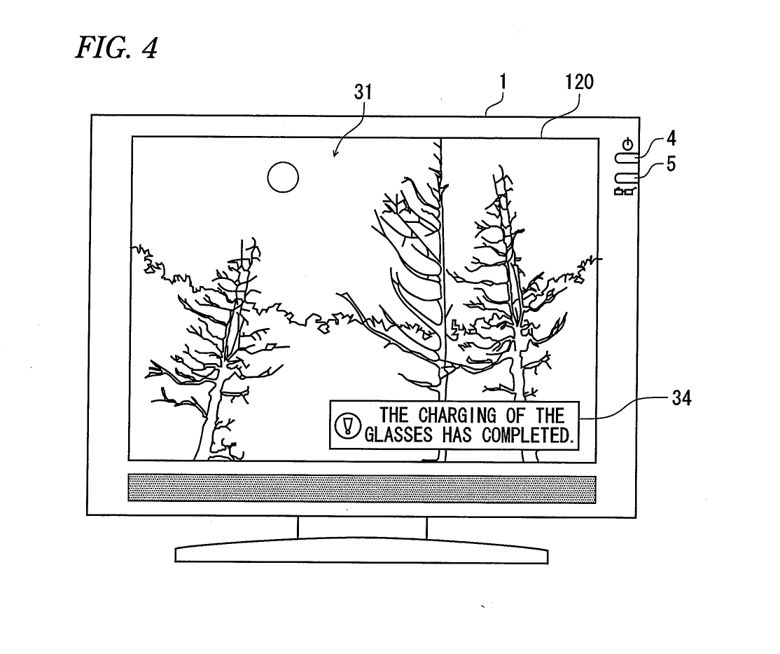

The charging status display generating module 172 has a function of generating signals for charging status display and charging completion display according to an instruction from the charging controller 171. The charging status display generating module 172 generates a signal for charging status display based on a charging status display generation instruction and a current battery residual capacity of the shutter glasses 2 and a continuously drivable (usable) time of the shutter glasses 2. The charging status display generating module 172 generates a signal for charging completion display based on a charging completion display generation instruction. The charging status display generating module 172 supplies the generated signal for display to the OSD signal generating module 164, whereby the signal is displayed as a UI picture so as to be superimposed on a full-screen image being displayed. Displays that are made in this manner will be described later with reference to FIGS. 3 and 4.

Next, the internal configuration of the shutter glasses 2 will be described.

The shutter glasses 2 are equipped with a signal-for-glasses receiving module 21, the battery 22, a battery controller 23, a shutter driving module 24, and a shutter module 25.

For example, the signal-for-glasses receiving module 21 is an infrared light reception module and has a function of receiving an opening/closing signal that is transmitted from the signal-for-glasses transmitting module 162 of the DTV 1 by infrared light. The signal-for-glasses receiving module 21 supplies a signal produced from a received opening/closing signal to the shutter driving module 24.

The battery 22 has a function of storing supplied electric energy.

The battery controller 23 is connected to the connection cable 3 via the terminal 26 and has a function of controlling the storage, in the battery 22, of electric energy supplied via the connection cable 3. The battery controller 23 supplies power from the battery 22 to the signal-for-glasses receiving module 21 and the shutter driving module 24. The battery controller 23 also has a function of detecting a residual capacity of the battery 22. When receiving a batter residual capacity information transmission request from the DTV 1, the battery controller 23 detects a residual capacity of the battery 22 and transmits battery residual capacity information to the DTV 1 via the connection cable 3 which is connected to the terminal 26. Furthermore, when charging of the batter 22 has completed, the battery controller 23 transmits information (signal) indicating completion of the charging to the DTV 1.

The shutter driving module 24 has a function of switching the transmission/stop of light of the shutter module 25 by applying voltages to the shutter module 25. The shutter driving module 24 controls the switching of the transmission/stop of light of each of the left-eye shutter 6 and the right-eye shutter 7 of the shutter module 25 based on a signal produced from an opening/closing signal that is received from the signal-for-glasses receiving module 21.

The shutter module 25 consists of the left-eye shutter 6 and the right-eye shutter 7 each of whose transmission/stop of light is switched depending on whether or not a voltage is applied to it from the shutter driving module 24. Each of the left-eye shutter 6 and the right-eye shutter 7 is rendered transparent when it is not supplied with a voltage, and is rendered opaque when it is supplied with a voltage. The transmission/stop of light of each of the left-eye shutter 6 and the right-eye shutter 7 is switched, whereby to the user is provided with 3D video (image) according to the above-described principle.

In the embodiment, the DTV 1 makes, on the display module 120, a charging status display which indicates a charging status of the shutter glasses 2. The charging status display will be described next.

FIG. 3 shows a general appearance of the DTV 1 in a state that a charging status display 32 according to the embodiment is being made. The charging status display 32 which is superimposed on a full-screen display image 31 being displayed on the display module 120 includes a charging meter 33. The DTV 1 is provided with the power indicator 4 and the charging indicator 5 in addition to the display module 120.

The display image 31 is video of an ordinary TV broadcast, for example. The DTV 1 displays the charging status display 32 on the display module 120 in response to an operation of the remote controller 117 by the user. The charging status display 32 shows a current charging status of the shutter glasses 2. More specifically, the charging status display 32 includes the charging meter 33 which shows, in percentage, a charging ratio which is a ratio of a current charging amount to a maximum charging amount of the shutter glasses 2. The shutter glasses 2 is not provided with any means for showing a current charging status to the user; the user can recognize a charging status through the charging status display 32 that is displayed by the DTV 1. Since the charging status display 32 indicates a current charging status of the shutter glasses 2 in detail, the user can detach the shutter glasses 2 being charged from the DTV 1 with proper timing. The charging status display 32 also includes a continuously usable (drivable) time which is a time for which the shutter glasses 2 can be driven continuously starting from the current charging amount. This allows the user to recognize how long he or she can view 3D video if stopping the charging of the shutter glasses 2 at present. If the user knows the duration of a 3D content he or she wants to view, the user can charge the shutter glasses 2 to a level that is suitable for the duration of the 3D content and then use the shutter glasses 2 in a disconnected state. Displaying the charging meter 33 and the continuously usable time thus makes the DTV 1 very convenient to the user.

The charging indicator 5 is lit while the shutter glasses 2 are being charged. The charging indicator 5 is supplied with power even while the DTV 1 is in a standby state. The charging controller 171 transmits a battery residual capacity information transmission request to the shutter glasses 2 at prescribed intervals even while the DTV 1 is in a standby state, and has a function of varying the lighting color of the charging indicator 5 according to acquired battery residual capacity information. For example, the charging indicator 5 is lit in red when the charging ratio is 0% to 50%, in orange when the charging ratio is 50% to close to 100%, and in green when the charging has completed. With this measure, the user can recognize a charging status of the shutter glasses 2 even while the DTV 1 is in a standby state (in terms of the power state).

When the charging of the shutter glasses 2 has been completed, the DTV 1 displays a charging completion display 34. FIG. 4 shows a general appearance of the DTV 1 in a state that the charging completion display 34 according to the embodiment is displayed.

When the charging of the shutter glasses 2 has been completed, the DTV 1 displays the charging completion display 34 which indicates completion of the charging by performing the above-described processing. This allows the user to recognize that the charging has been completed.

Next, a process relating to the charging status display and the charging completion display which is executed by the DTV 1 will be described.

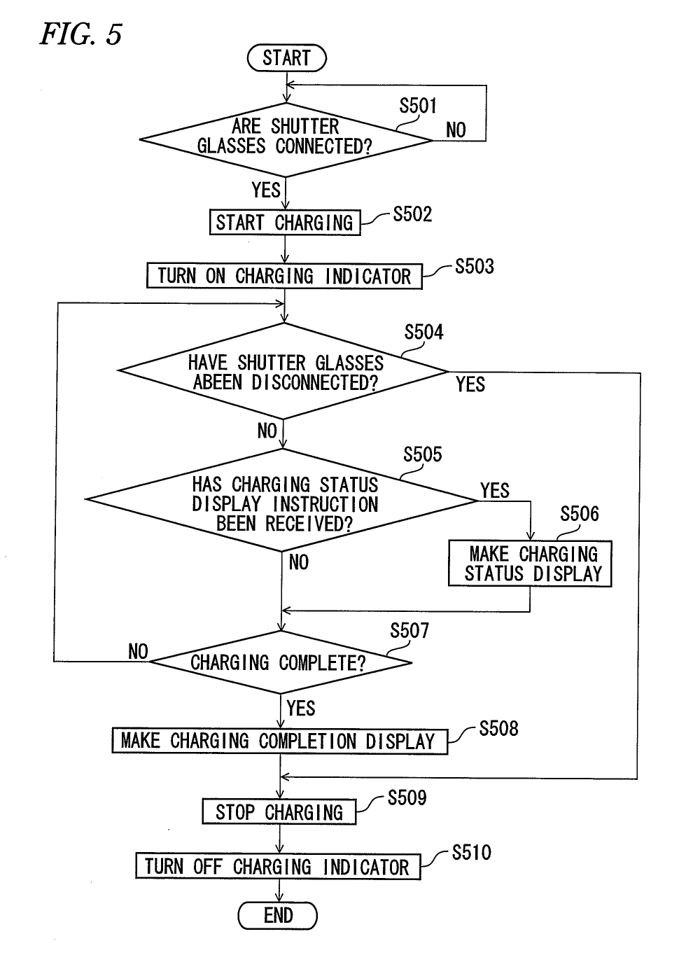

FIG. 5 is a flowchart of an example process relating to the charging status display and the charging completion display which is executed by the DTV 1 according to the embodiment.

First, at step S501, the controller 156 determines whether or not the connection cable 3 that is connected to the shutter glasses 2 is connected to the USB terminal 133. If the connection cable 3 (shutter glasses 2) is not connected to the USB terminal 133 (S501: no), the process returns to step S501. The controller 156 stands by until the connection cable 3 is connected.

If the connection cable 3 that is connected to the shutter glasses 2 is connected to the USB terminal 133 (S501: yes), at step S502 the controller 156 instructs the power controller 167 to start charging the shutter glasses 2.

Upon the start of charging of the shutter glasses 2, at step S503 the controller 156 turns on the charging indicator 5.

At step S504, the controller 156 determines whether or not the connection cable 3 (shutter glasses 2) has been disconnected from the DTV 1.

If the connection cable 3 (shutter glasses 2) has not been disconnected (S504: no), the controller 156 determines at step S505 whether or not a charging status display instruction has been received from the remote controller 117.

If a charging status display instruction has been received (S505: yes), the charging controller 171 transmits a battery residual capacity information transmission request to the shutter glasses 2. When receiving the battery residual capacity information transmission request, the battery controller 23 of the shutter glasses 2 detects a charging amount of the battery 22 and transmits information of the detected charging amount to the DTV 1 as battery residual capacity information. When receiving the battery residual capacity information, the charging controller 171 calculates a continuously drivable (usable) time based on the received battery residual capacity information and supplies the charging status display generating module 172 with a charging status display generation instruction together with the battery residual capacity information and the continuously drivable (usable) time information. The charging status display generating module 172 generates a signal for charging status display based on the pieces of information received from the charging controller 171 and displays a charging status display on the display module 120 (step S506).

The charging controller 171 transmits a battery residual capacity information transmission request to the shutter glasses 2 at prescribed intervals. The charging controller 171 determines whether or not the charging of the shutter glasses 2 has been completed based on received battery residual capacity information (step S507). Alternatively, whether or not the charging of the shutter glasses 2 has been completed may be determined based on whether or not information indicating completion of the charging has been received from the battery controller 23 of the shutter glasses 2.

If the charging controller 171 determines that the charging of the shutter glasses 2 has not been completed yet (S507: no), the process returns to step S504.

If judging that the charging of the shutter glasses 2 has been completed (S507: yes), the charging controller 171 instructs the charging status display generating module 172 to generate a signal for charging completion display . In response, at step S508 the charging status display generating module 172 generates a signal for charging completion display and displays a charging completion display on the display module 120.

When execution of step S508 has completed or if it is determined that the connection cable 3 (shutter glasses 2) has been disconnected from the DTV 1 (S504: yes), at step S509 the controller 156 instructs the power controller 167 to stop charging the shutter glasses 2.

Finally, at step S510, the controller 156 instructs the indicator module 165 to turn off the charging indicator 5. The charging indicator 5 is thus turned off.

The process of FIG. 5 is thus finished.

In the embodiment, while the power of the DTV 1 is on, the user is notified of a charging status of the shutter glasses 2 by means of a charging status display or the like. While the DTV 1 is in a standby state, the user is notified of a charging status of the shutter glasses 2 by means of the charging indicator 2. With these measures, the user can recognize the progress of charging of the shutter glasses 2 irrespective of whether the DTV 1 is in a power-on state or a standby state (in terms of the power state).

The DTV 1 according to the embodiment generates a display containing information that relates to charging of the shutter glasses 2 and presents that information to the user. As a result, the user can use the shutter glasses 2 easily and conveniently.

While certain embodiments have been described, these embodiments have been presented by way of example only, and are not intended to limit the scope of the invention. Indeed, the novel apparatus, method and system described herein may be embodied in a variety of other forms; furthermore, various omissions, substitutions and changes in the form of the apparatus, the method and the system described herein may be made without departing from the spirit of the invention. The accompanying claims and their equivalents are intended to cover such forms or modifications as would fall within the scope and spirit of the invention.

What is claimed is:

1. An image display system comprising:
a digital television receiver configured to display on a screen images in a format configured to viewed in 3D; and
rechargeable 3D image viewing glasses configured to allow a user to view in 3D the images displayed on the screen in the 3D-viewable format, the 3D image viewing glasses comprising
a rechargeable battery, and
a charging circuit configured to detect a charge amount of the battery and transmit battery residual-capacity information relating to the detected charge amount to the digital television receiver, and
the digital television receiver being configured to recharge the 3D image viewing glasses and comprising
a power transmitter configured to allow power to be transmitted to the rechargeable battery of the 3D image viewing glasses,
a receiving processor configured to receive the battery residual-capacity information from the battery processor of the 3D image viewing glasses,
a display processor configured to display on the screen an image representing the charge amount of the 3D image viewing glasses based on the received battery residual-capacity information, and
a power controller configured to switch between a first state, configured to allow the power transmitter to transmit power to the rechargeable battery, and a second state, configured to allow for display of the 3D-viewable images.

2. The image display system of claim 1, further comprising an indicator comprising a light-emitting diode configured to indicate a charge state of the 3D image viewing glasses.

3. An image display apparatus comprising:
a power transmitter configured to allow power to be transmitted to rechargeable 3D image viewing glasses, thereby allowing the rechargeable 3D image viewing glasses to be recharged;
a receiving module configured to receive information relating to a charge amount of the 3D image viewing glasses; and
a display module configured to display an image representing the charge amount of the 3D image viewing glasses based on the information relating to the charge amount.

4. The apparatus of claim 3, further comprising:
an instruction transmitting module configured to transmit, to the 3D image viewing glasses, an instruction signal to transmit information relating to the charge amount of the 3D image viewing glasses.

5. The apparatus of claim 3, further comprising:
a power controller configured to switch between a power-on state and a standby state,
wherein the power transmitting module is configured to transmit the power in the standby state.

6. The apparatus of claim 3, wherein the display module is configured to display a charging ratio defining a ratio of a current charge amount to a maximum charge amount of the 3D image viewing glasses based on the information relating to the charge amount.

7. The apparatus of claim 3, wherein the display module is configured to display a usable time of the 3D image viewing glasses based on the information relating to the charge amount.

8. The apparatus of claim 3, wherein the display module is configured to display a message indicating that charging of the 3D image viewing glasses has been completed based on the information relating to the charge amount.

9. The apparatus of claim 5, further comprising:
an indicator configured to display a visual indication based on the information relating to the charge amount,
wherein the indicator is configured to display the visual indication based on the information relating to the charge amount when the apparatus is in the standby state.

10. The apparatus of claim 9, wherein the indicator comprises a light-emitting diode.

11. A display method performed in an image display apparatus comprising:
electrically connecting to 3D image viewing glasses;
transmitting power to the connected 3D image viewing glasses;
receiving information relating to a charge amount of the 3D image viewing glasses; and
displaying an image representing the charge amount of the 3D image viewing glasses based on the information relating to the charge amount.

12. The method of claim 11, further comprising determining whether the charge amount of the 3D image viewing glasses has reached a predetermined maximum charge value, and
if the charge amount has reached the predetermined maximum charge value, setting the image to represent that charging of the 3D image viewing glasses is complete, and
if the charge amount has not reached the predetermined maximum charge value, setting the image to represent an amount of time that the 3D image viewing glasses can be used for viewing 3D images displayed on the image display apparatus.
